(19) United States
(12) Patent Application Publication
(10) Pub. No.: US 2015/0282266 A1
(43) Pub. Date: Oct. 1, 2015

(54) LIGHT ADJUSTABLE AC LED DEVICE

(71) Applicant: PROLIGHT OPTO TECHNOLOGY CORPORATION, TaoYuan County (TW)

(72) Inventors: Chen-Lun HSING CHEN, TaoYuan County (TW); Hsu-Keng TSENG, TaoYuan County (TW); Jung-Hao HUNG, TaoYuan County (TW)

(73) Assignee: PROLIGHT OPTO TECHNOLOGY CORPORATION, TaoYuan County (TW)

(21) Appl. No.: 14/275,901

(22) Filed: May 13, 2014

(30) Foreign Application Priority Data
Mar. 26, 2014 (TW) 103111283

(51) Int. Cl. H05B 33/08

(52) U.S. Cl. CPC H05B 33/0845; H05B 33/0857; H05B 33/0809; H05B 33/083

(57) ABSTRACT

A light adjustable AC (alternating-current) LED device is provided. A color temperature of the light adjustable AC LED device is decreased as decreased brightness thereof. The light adjustable AC LED device includes an AC power source, a plurality of power loops and a plurality of LED segments. The AC power source is for providing an AC voltage. Each of the power loops is electrically connected with the AC power source, and each of the LED segments is electrically connected with each power loop. When the AC voltage is gradually raised, each LED segment of each power loop is turned-on in sequence, thereby a color temperature of each LED segment being mixed in sequence; when the AC voltage is gradually dropped, each LED segment of each power loop is turned-off in reverse order.

### RELATED APPLICATIONS

The application claims priority to Taiwan Application Serial Number 103111283, filed on Mar. 26, 2014, which is herein incorporated by reference.

### BACKGROUND

1. Technical Field

The present disclosure relates to a LDi) device, especially relates to a light adjustable AC LED device that a color temperature thereof is varied with varied brightness thereof.

2. Description of Related Art

Owing to superior characteristics on high lighting efficiency, low energy constumption, and high lighting efficiency of LED (light emitting diode), conventional incandescent lamp is gradually replaced by LED.

Commonly, the light emitting diode is driven by a DC (direct current) power source, or is driven by a power converter which converts an AC (alternating current) power source to a DC power source. However, such power converter generally provides lower converting efficiency, thereby leading to high energy loss, high noise and instable current. Furthermore, commercially available electric power source is an AC power source so that a LED device which can be driven by the AC power source is highly demanded.

Nowadays, AC LED devices have been available in the market. However, optical performances of these AC LED devices are not comparable with conventional incandescent lamps. For an example, color temperature, brightness and light color of the conventional AC LED devices are limited owing to circuit design thereof.

Therefore, a demand for a light adjustable AC LED device which can provide the same or superior optical performance as the conventional incandescent lamp is increasing.

### SUMMARY

According to one aspect of the present disclosure, a light adjustable AC LED device is provided. A color temperature of the light adjustable AC LED device is decreased as decreased brightness thereof. The light adjustable AC LED device includes an AC power source, a plurality of power loops and a plurality of LED segments. The AC power source is for providing an AC voltage. Each of the power loops is electrically connected with the AC power source. Each of the LE segments is electrically connected with each power loop. Wherein when the AC voltage is raised, each LED segment connected with each power loop is turned-on in sequence, thereby a color temperature of each LED segment are mixed in sequence; when the AC voltage is dropped, each LED segment connected with each power loop is turned-off in reverse order.

According to another aspect of the present disclosure, a light adjustable AC LED device is provided. A color temperature of the light adjustable AC LED device is decreased as decreased brightness thereof. The light adjustable AC LED device includes an AC power, a plurality of power loops, a first LED segment, a second LED segment and a third LED segment. The AC power source is for providing an AC voltage. Each of the plurality of power loops includes at least one LED unit, wherein the LED units are defined as a first LED segment, a second LED segment and a third LED segment; wherein when the when the AC voltage is raised the LED units of first LED segment are turned-on for providing a first color temperature, then the LED units of the second LED segment are turn-on for providing a second color temperature, wherein the first color temperature and the second color temperature are mixed for forming a mixed color temperature, and then the LED units of the third LED segment are turned-on for providing a third color temperature, wherein the first color temperature, the second color temperature and the third temperature are mixed for forming another mixed color temperature; wherein the first color temperature is lower or equal to the second color temperature, and the second color temperature is lower or equal to the third color temperature; when the AC voltage is dropped, the LED units of the first LED segment, the LED units of the second LED segment and the LED) units of the third LED segment are turned-off in reverse order.

According to still another aspect of the present disclosure, a light adjustable AC LED device is provided. A color temperature of the light adjustable AC LED device is decreased as decreased brightness thereof. The light adjustable AC LED device includes an AC power, a rectifier, a plurality of LED units and a semiconductor controlling component. The AC power source is for providing an AC voltage. The rectifier is connected with the AC power source for rectifying the AC voltage and outputting a rectified AC voltage. The LEI) units are connected in series for receiving the rectified AC voltage and defining a plurality of LED segments. One ground terminal of the semiconductor controlling component is connected to the ground; another ports of the semiconductor controlling component are electrically connected to the LED segments for forming a plurality of power loops. Wherein when the AC voltage is raised; each LED segment of each power loop is turned-on in sequence, thereby a color temperature of each LED segment is mixed in sequence; when the AC voltage is dropped, each LED segment of each power loop is turned-off in reverse order, thereby the color temperature of each LED segment is lowered in reverse order.

### BRIEF DESCRIPTION OF THE DRAWINGS

The present disclosure can be more fully understood by reading the following detailed description of the embodiment, with reference made to the accompanying drawings as follows:

FIG. 1 is a schematic view showing a light adjustable AC LED device according to one embodiment of the present disclosure;

FIG. 2 is a voltage-phase diagram of the light adjustable AC LED device of FIG.

FIG. 3 is a schematic view showing operation procedures of the light adjustable AC LED device of FIG. 1; and

FIG. 4 is a schematic view showing an application of the light adjustable AC LED device according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The present disclosure provides a light adjustable AC LED device. An AC power source is rectified by a rectifier, and a plurality of power loops can be formed through functionality of a semiconductor controlling component. A plurality of individually controlled LED segments is formed. Each of the LED segments is formed on each of the power loops. When the light adjustable AC LED device is turned-on, each of the LED segments can be turned-on in sequence for emitting light, and the color temperature is increased with the increased brightness. When the light adjustable AC LED device is turned-off, each of the LED segments can be turned-off in reverse order, and the color temperature is decreased with the decreased brightness. Therefore, the color temperature is gradually mixed or gradually lowered, thereby achieving a light adjusting effect.

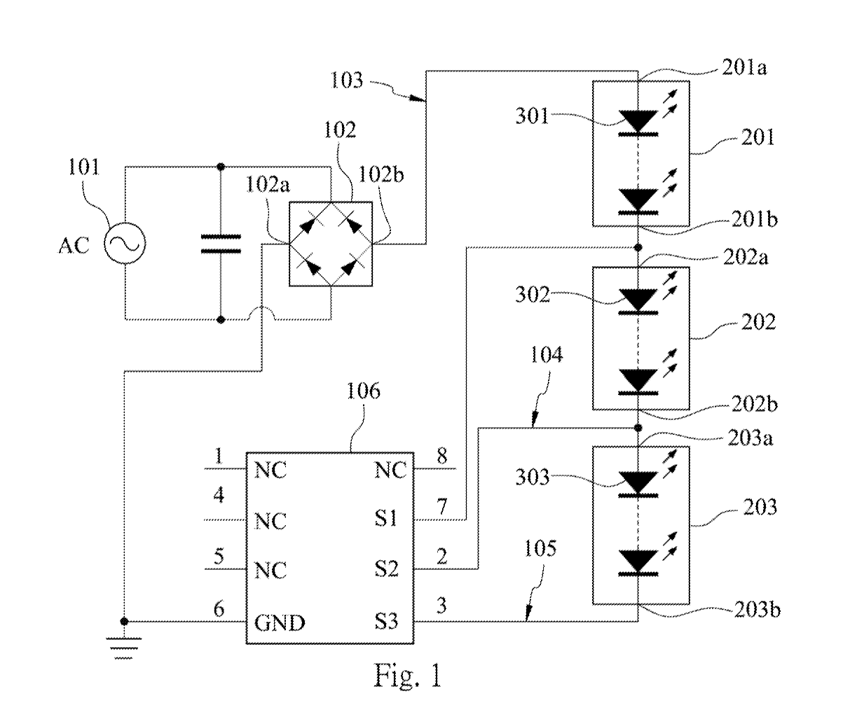

FIG. 1 is a schematic view showing a light adjustable AC LED device according to one embodiment of the present disclosure. The light adjustable AC LED device essentially includes an AC power source 101, a bridge rectifier 102 and a plurality of LED segments. In the embodiment, a first LED segment 201, a second LED segmelnt and a third LED segment 203 are formed in the light adjustable AC LED device. It should be known that the quantity of the LED segments is not limited. The AC power source 101 provides an AC voltage in order to drive the light adjustable AC LED device. The bridge rectifier 102 is electrically connected to the AC power source 101 for inverting a negative half-cycle of the AC voltage to a positive half-cycle, thereby generating a fall-wave rectified AC voltage. A semiconductor controlling component is electrically connected with the first LED segment 201, the second LED segment and the third LED segment 203. The semiconductor controlling component 106 includes a ground terminal GND and at least three ports, which are the first port S1, the second port S2 and the third port S3. The ground terminal GND of the semiconductor controlling component 106 is coupled with a port 102a of the bridge rectifier 102 to the ground. Another port 102b of the bridge rectifier 102 is electrically connected to an input end 201a of the first LED segment 201. An output end 201b is electrically connected to the first port S1 of the semiconductor controlling component 106. Therefore, a firt power loop 103 is formed, and the first LED segment 201 can be driven for emitting light.

The first LED segment 201, the second LED segment 202 and the third LED segment 203 are connected in series. An input end 202a of the second LED segment is electrically connected to the first port S1 of the semiconductor controlling component 106, and an output end 202b of the second LED segment 202 is electrically connected to the second port S2 of the semiconductor controlling component 106. Therefore, a second power loop 104 is formed, and the second LED segment 202 can be driven for emitting light. Similarly, an input end 203a of the third LED segment 203 is electrically connected to the second port S2 of the semiconductor controlling component 106, and an output end 203b of the third LED segment 203 is electrically connected to the third port S3 of the semiconductor controlling component 106. Therefore, a third power loop 105 is formed, and the third LED segment 203 can be driven for emitting light.

The aforementioned first LED segment 201, second LED segment 202 or third LED segment 203 can be individually formed by a single LED unit or a plurality of LED units connected in series. For example, the first LED segment 201 can be formed by only one LED unit 301 or series-connected LED units 301. Similarly, the second LED segment 202 can be formed by only one LED unit 302 or series-connected LED units 302, and the third LED segment 203 can be formed by only one LED unit 303 or series-connected LED units 303.

The first LED unit 301, the second LED unit 302 and the third LED unit 303 can emit different light color respectively. In one example, the first LED unit 301 is a red LED with a first color temperature T1, the second LED unit 302 is a green LED with a second color temperature T2, and the third LED unit 303 is a blue LED with a third color temperature T3.

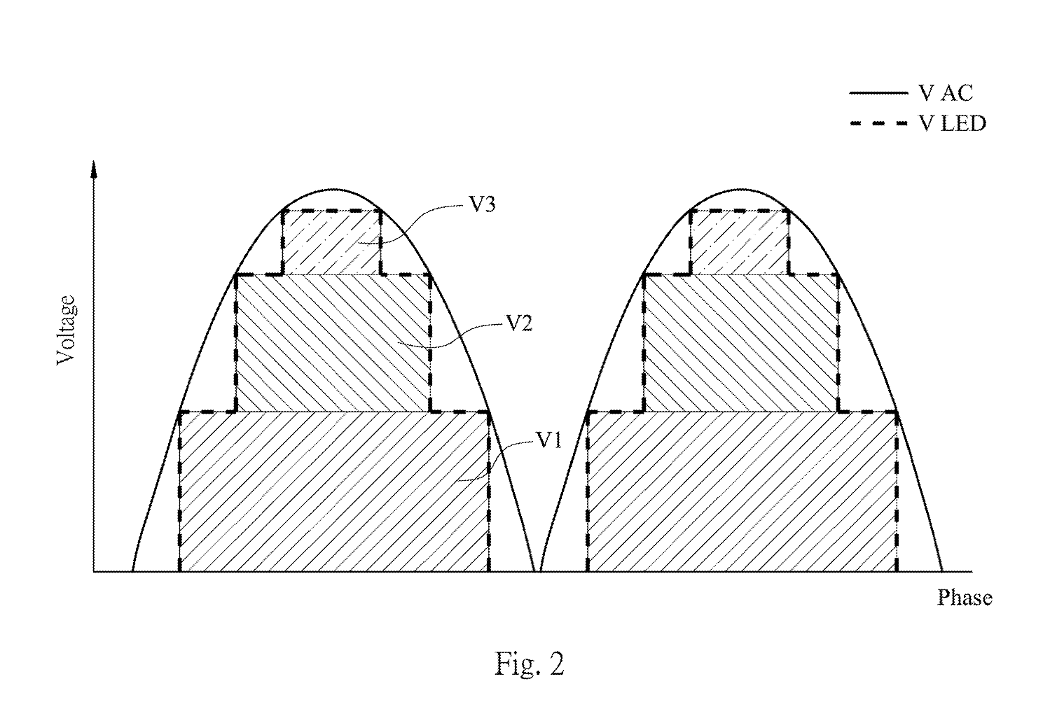

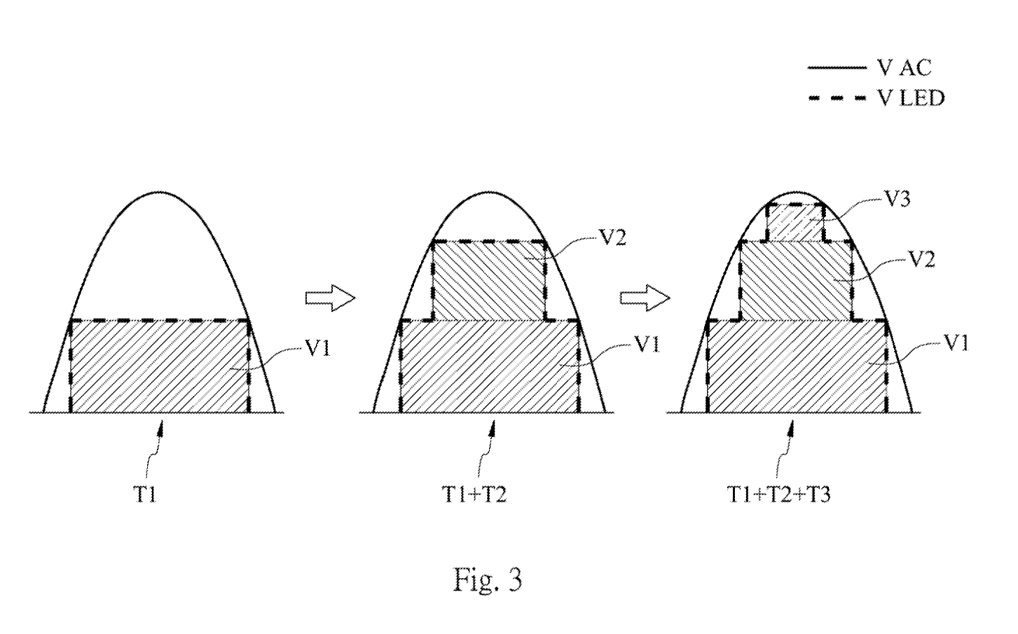

FIG. 2 is a voltage-phase diagram of the light adjustable AC LED device of FIG. 1. FIG. 3 is a schematic view showing operation procedures of the light adjustable AC LED device of FIG. 1. In the light adjustable AC LED device, the bridge rectifier 102 is utilized for rectifying the AC power source 101, and the semiconductor controlling component 106 is utilized for forming the first power loop 103, the second power loop and the third power loop 105, in order to control the first LED segment 201, the second LED segment 202 and the third LED segment 203 respectively. In FIG. 2, a full-wave rectified AC voltage is generated through rectifying the AC power source 101 by the bridge rectifier 102. A driving voltage V1, a driving voltage V2 and a driving voltage V3 are formed in sequence with the increased AC voltage, therefore the first LED segment 201, the second LED segment 202 and the third LED segment 203 are driven for emitting light in sequence.

In operation, when the AC voltage provided by the AC power source 101 is gradually raised, the first LED segment 201 is turned-on first, then the second LED segment 202 is turned-on, and finally the third LED segment 203 is turned-on.

In detail, the first LED unit 301 of the first LED segment 201 is turned-on first and the first color temperature T1 is formed, then the second LED unit 302 of the second LED segment 202 is turned-on and the second color temperature T2 is formed, and finally the third LED unit 303 of the third LED segment 203 is turned-on and the third color temperature T3 is formed. The first color temperature T1 is lower or equal to the second color temperature T2, and the second color temperature T2 is lower or equal to the third color temperature T13.

In FIG. 3, when the AC voltage provided by the AC power source 101 is initially raised, the first power loop 103 provides the driving voltage V1 and the first LED segment 201 is tuned-on for generating the first color temperature T1. Then, with the continuously-raised AC voltage, the second power loop 104 provides the driving voltage V2 and the second LED segment 202 is turned-on for generating the second color temperature T2. Now for the whole light adjustable AC LED device, with the increased brightness, a light color thereof is a mixing of a light color of the first LED unit 301 of the first LED segment 201 and a light color of the second LED unit 302 of the second LED segment 202, and a mixed color temperature thereof is an mixing of the first color temperature T1 and the second color temperature T2. When the AC voltage is continuously-raised, the third power loop 105 provides the driving voltage V3 and the third LED segment 203 is turned-on for generating the third color temperature T3. Now for the whole light adjustable AC LED device, with the increased brightness, a light color thereof is a mixing of the light color of the first LED unit 301 of the first LED segment 201, the light color of the second LED unit 302 of the second LED) segment 202 and a light color of the third LED unit 303 of the third LED segment 203, and a mixed color temperature thereof is an mixing of the first color temperature T1, the second color temperature T2 and the third color temperature T3. The first color temperature T1 is lower or equal to the second color temperature T2, and the second color temperature T2 is lower or equal to the third color temperature T3.

In on example, when the first LED unit 301 is a red LED, the second LED unit is a green LED, and the third LED unit 303 is a blue LED, with the increased AC voltage, the whole light adjustable AC LED device can emit a white light with meticulous color temperature. Thus, the light adjustable AC LED device can behave as the conventional incandescent lamp, and the light color, the brightness and the color temperature can reach the same or superior lighting effect as the conventional incandescent lamp.

According to the aforementioned situation, the AC voltage is directly raised (turned-on situation). On the contrary, when the AC voltage provided by the AC power source 101 is gradually dropped, the third LED segment 203 is turned-off first, then the second LED segment 202 is turned-off, finally the first LED segment 201 is turned-off. In the situation that the AC voltage is gradually turned-off, the third color temperature T3 is first lowered, then the second color temperature T2 is lowered, finally the third color temperature T3 is lowered. In this circumstance, when the whole light adjustable AC LED device is turned-off, meticulous color temperature variance can also be obtained.

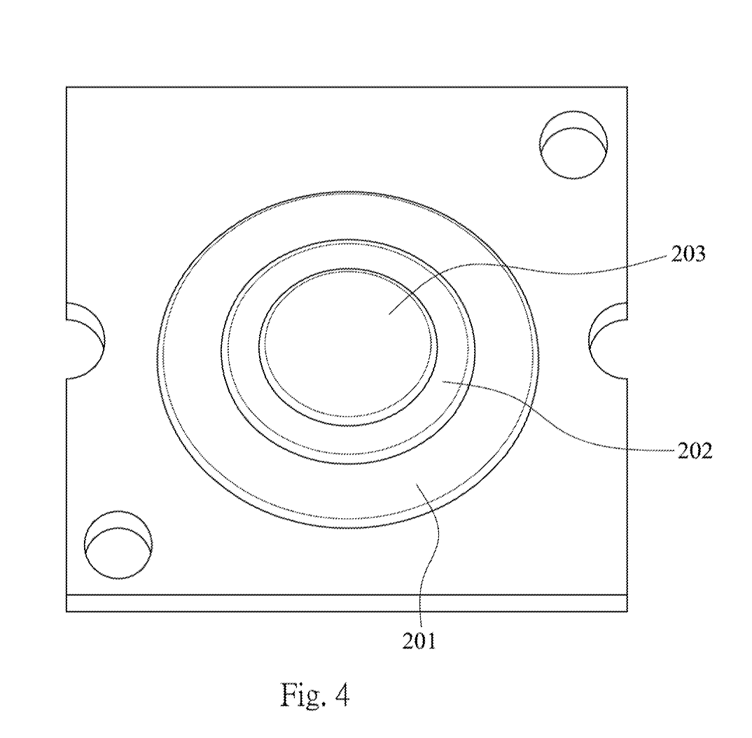

FIG. 4 is a schematic view showing an application of the light adjustable AC LED device according to one embodiment of the present disclosure. In FIG. 4, the first LED segment 201, the second LED segment 202 and the third LED segment 203 of the light adjustable AC LED device utilize LED units with different colors. When the light adjustable AC LED device is turned-on, the color temperature is increased with the increased brightness; and when the light adjustable AC LED device is turned-off, the color temperature is decreased with the decreased brightness. Therefore, the color temperature can be meticulously controlled, and the light color and the brightness are more uniform.

In the aforementioned embodiments, the quantity of the LED segments is not limited. For example, more than three power loops can be connected with more than three LED segments for obtaining more meticulous control on the color temperature thus the light adjustable AC LED device can behave as the conventional incandescent lamp. Moreover, in the light adjustable AC LED device of the present disclosure, the package type of the LED units or the LED segments is also not limited. For example, COB (Chip On Board) can be utilized, and the first LED segment 201, the second LED segment 202 and the third LED segment 203 can be assembled into a COB type LED device. In one example, a TRIAC dimmer can be combined to the light adjustable AC LED device for adjusting the brightness of each LED segment, thus a more accurate light adjusting effect can be achieved.

In conclusion, a light adjustable AC LED device is provided in the present disclosure. Each LED segment is turned-on or turned-off in sequence, thus the color temperature of the whole light adjustable AC LED device can be continuously-varied with the varied brightness, thereby achieving similar or superior lighting effect as the conventional incandescent lamp.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the ar that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A light adjustable AC (Alternating-Current) LED (Light Emitting Diode) device, wherein a color temperature thereof is decreased as decreased brightness thereof, the light adjustable AC LED device comprising:
an AC power source for providing an AC voltage;
a plurality of power loops, each of the power loops electrically connected with the AC power source; and
a plurality of LED segments, each of the LED segments electrically connected with each power loop;
wherein when the AC voltage is raised, each LED segment connected with each power loop is turned-on in sequence, thereby a color temperature of each LED segment are mixed in sequence;
when the AC voltage is dropped, each LED segment connected with each power loop is turned-off in reverse order.

2. The light adjustable AC LED device of claim 1, further comprising:
a bridge rectifier electrically connected with the AC power source for inverting a negative half-cycle of the AC voltage to a positive half-cycle, thereby generating a fill-wave rectified AC voltage.

3. The light adjustable AC LED device of claim 2, further comprising:
a semiconductor controlling component, wherein the semiconductor controlling component comprises a ground terminal and a plurality of ports, the ground terminal is coupled with one port of the bridge rectifier to the ground, another port of the bridge rectifier is connected with one end of one of the LED segments, each port of the semiconductor controlling component is connected witt each LED segment for forring each power loop.

4. A light adjustable AC LED device, wherein a color temperature thereof is decreased as decreased brightness thereof, the light adjustable AC LED device comprising:
an AC power source for providing an AC voltage; and
a plurality of power loops, each power loop comprising at least one LED unit, wherein the LED units are defined as a first LED segment, a second LED segment and a third LED segment;
wherein when the AC voltage is raised, the LED units of the first LED segment are turned-on for providing a first color temperature and the LED units of the second LED segment are turn-on for providing a second color temperature, wherein the first color temperature and the second color temperature are mixed for forming a mixed color temperature; then the LED units of the third LED segment are turned-on for providing a third color temperature, wherein the first color temperature, the second color temperature and the third temperature are mixed for forming another mixed color temperature, wherein the first color temperature is lower or equal to the second color temperature, the second color temperature is lower or equal to the third color temperature;
when the AC voltage is dropped, the LED units of the first LED segment, the LED units of the second LED segment and the LED units of the third LED segment are turned-off in reverse order.

5. The light adjustable AC LED device of claim 4, further comprising:
a bridge rectifier electrically connected with the AC power source for inverting a negative half-cycle of the AC voltage to a positive half-cycle, thereby generating a full-wave rectified AC voltage.

6. The light adjustable AC LED device of claim 4, wherein the first LED segment, the second LED segment and the third LED segment are assembled into a COB type LED device.

7. The light adjustable AC LED device of claim 5, further comprising:
a semiconductor controlling component, wherein the semiconductor controlling component comprises an ground terminal and a plurality of ports, the ground terminal is coupled with one port of the bridge rectifier to the ground, another port of the bridge rectifier is connected with one end of the first LED segments, each port of the semiconductor controlling component is connected with each LED segment for forming each power loop.

8. A light adjustable AC LED device, wherein a color temperature thereof is decreased as decreased brightness thereof, the light adjustable AC LED device comprising:
an AC power source for providing an AC voltage;
a rectifier connected with the AC power source for rectifying the AC voltage and outputting a rectified AC voltage;
a plurality of LED units connected in series for receiving the rectified AC voltage and defining a plurality of LED segments; and
a semiconductor controlling component, one ground terminal of the semiconductor controlling component being connected to the ground, another ports of the semiconductor controlling component being electrically connected to the plurality of LED segments for forming a plurality of power loops;
wherein when the AC voltage is raised;
each LED segment of each power loop is turned-on in sequence, thereby a color temperature of each LED segment is mixed in sequence;
when the AC voltage is dropped, each LED segment of each power loop is turned-off in reverse order, thereby the color temperature of each LED segment is lowered in reverse order.

9. The light adjustable AC LED device of claim 8, further comprising a bridge rectifier electrically connected with the AC power source for inverting a negative half-cycle of the AC voltage to a positive half-cycle, thereby generating a full-wave rectified AC voltage.

10. The light adjustable AC LIED device of claim 8, wherein each LED segment comprises a LED unit or a plurality of LED units connected in series.

11. The light adjustable AC LED device of claim 10, wherein the LED unit is a COB packaged LED unit.

12. The light adjustable AC LED device of claim 8, further comprising a TRIAC dimmer for adjusting brightness of each LED segment.
